(19) United States
(12) Patent Application Publication
(10) Pub. No.: US 2022/0292622 A1
(43) Pub. Date: Sep. 15, 2022

(54) ANONYMOUS CRIME REPORTING AND ESCROW SYSTEM WITH HASHED PERPETRATOR MATCHING

(71) Applicant: JDOE, PBC, Washington, DC (US)

(72) Inventor: Ryan SOSCIA, Washington, DC (US)

(73) Assignee: JDOE, PBC, Washington, DC (US)

(21) Appl. No.: 17/200,699

(22) Filed: Mar. 12, 2021

(51) Int. Cl. G06Q 50/26; G06Q 10/10; H04L 9/32; G06F 21/60; G06F 16/245

(52) U.S. Cl. CPC G06Q 50/265; G06Q 10/10; H04L 9/3242; G06F 21/602; G06F 16/245; G06Q 2220/10

(57) ABSTRACT

A crime reporting system that lets victims or witnesses submit encrypted reports anonymously, and that searches for repeat offenders without decrypting submitted data. Perpetrator information is transformed into cryptographic hashes that are used to match repeat offenders while preserving anonymity. Reporting users may be informed when their report matches others on the same perpetrator, so that they may consider joint action against the perpetrator. Users may also be informed of law firms that represent other victims of the same perpetrator or similar cases; they may select a law firm and may choose to share the unencrypted data with a selected firm. Reports and attached evidence are escrowed securely in the system's database; unencrypted data is never stored. Hashes may include variations of the submitted data; for example, name variations such as “Tom”, “Thomas”, and “Tommy” may be detected as being the same perpetrator.

### BACKGROUND OF THE INVENTION

### Field of the Invention

One or more embodiments of the invention are related to the fields of encryption and information systems security. More particularly, but not by way of limitation, one or more embodiments of the invention enable an anonymous crime reporting and escrow system with hashed perpetrator matching.

### Description of the Related Art

Systems for reporting crimes are known in the art, including systems such as anonymous tip lines that allow users to report crimes without revealing their identities. These systems typically provide only one-way communication: a user submits a tip or report, and authorities may then investigate further. These systems provide no feedback or assistance to the reporting user.

There are no known systems that allow a reporting user to submit an anonymous crime report, and that then analyze the submitted information, even though it is encrypted, to inform the user that the perpetrator may be a repeat offender. If a victim knows that a perpetrator has committed several crimes, and that other victims may be pursuing action, that victim may be encouraged to initiate or join such an action.

For at least the limitations described above there is a need for an anonymous crime reporting and escrow system with hashed perpetrator matching.

### BRIEF SUMMARY OF THE INVENTION

One or more embodiments described in the specification are related to an anonymous crime reporting and escrow system with hashed perpetrator matching. Embodiments of the invention may allow victims or witnesses of a crime to report the crime anonymously, with all data encrypted or protected including the identities of the reporting user and of the alleged perpetrator. The system may compare the submitted, secured information against other submitted complaints to determine whether the perpetrator is a repeat offender; this information may be provided to the reporting user. This functionality may be of particular value in crimes like sexual assault, where victims may be reluctant to come forward; if victims know that the perpetrator is a repeat offender, they may be encouraged to pursue joint action knowing that they are more likely to be believed. Embodiments of the invention may keep all information submitted by a reporting user encrypted until the reporting user chooses to explicitly share this information, for example with a law firm that offers to represent the victim or victims.

One or more embodiments of the invention may include a reporting system and a perpetrator matching system. The reporting system may include a reporting program that executes on a processor such as a computer or smart phone. This program may accept a crime report from a reporting user; the crime report may for example contain identifying characteristics of a perpetrator, the identity of the reporting user, and details of the crime such as the type, location, and time of the crime. The reporting program may transform the identifying characteristics of the perpetrator into a hashed perpetrator profile with cryptographic hashes associated with these identifying characteristics. It may transform the crime report into an encrypted crime report. It may form an anonymous complaint that contains the encrypted crime report and the hashed perpetrator profile; this complaint may not contain any key that may be used to decrypt the encrypted crime report. The anonymous complaint may be transmitted to the perpetrator matching system. The perpetrator matching system may have a complaint database that stores anonymous complaints and the associated hashed perpetrator profiles; the database may not contain any decryption keys for the encrypted crime reports. The perpetrator matching system may have a matching program that executes on a processor such as a server. The matching program may receive an anonymous complaint, and may search the complaint database for a match to the hashed perpetrator profile of the received anonymous complaint. When a match is found, a notification may be transmitted to one or more of a law firm, a victim assistance organization, a legal authority, a government agency, an employer, and the reporting user of the anonymous complaint.

A reporting user may be for example a victim of or a witness to the crime.

In one or more embodiments, the matching program may transmit a match notification to the reporting user, and this notification may include one or more of the number of complaints in the database that match the reported hashed perpetrator profile, and one or more law firms that represent users who have submitted complaints against this perpetrator. Any other reporting users who previously submitted complaints that match the reported hashed perpetrator profile may also be notified that a new report has been submitted that matches those users' reports.

One or more embodiments may also have a responding system with a responding program that executes on a processor such as a computer or a smart phone. A responder that uses the responding system may be for example a law firm or a person associated with a law firm. The responding program may receive notifications from the matching system and present these to a responder using the program.

In one or more embodiments, the reporting program may present to the reporting user a list of potential responders that represent similar cases to the crime report. The reporting user may select a particular responder, and the reporting program may transmit this selected responder to the matching system. The matching program may then transmit the anonymous complaint associated with the reporting user to the selected responder's system. The responding program of this responder may then receive the anonymous complaint and decrypt it to obtain the original crime report. The responding program may present one or more identifying characteristics of the perpetrator to the responder so that the responder can check for a conflict. The responder may then accept or reject to represent the reporting user, and this acceptance or rejection may be transmitted to the reporting user.

In one or more embodiments, perpetrator identifying characteristics may include one or more of name, phone number, location, social media identifier, email address, and workplace.

In one or more embodiments, the matching program may determine a match to a hashed perpetrator profile by summing a hash match score for each hash of the hashed perpetrator profile that matches a corresponding hashed profile of a perpetrator in the complaint database. If the sum of hash match scores exceeds a threshold, the perpetrator in the database may be a match.

In one or more embodiments, to calculate a hashed perpetrator profile, the reporting program may transform each identifying characteristic of the perpetrator into one or more normalized tokens, and may calculate a cryptographic hash of each normalized token. Calculation of normalized tokens may for example convert characters to lower case and remove non-alphabetic characters. It may for example transform a characteristic into one or more substrings of the characteristic; for example, a full name may be transformed into substrings for the first, middle and last names, or a phone number may be transformed into substrings for the area code, central office code, and suffix. It may for example transform a characteristic into a phonetic form that represents the pronunciation of the characteristic, or into a synonym or variation of the characteristic.

In one or more embodiments, the matching program may reject an anonymous complaint when the identity of the reporting user matches a hashed perpetrator profile in the complaint database.

### BRIEF DESCRIPTION OF THE DRAWINGS

The above and other aspects, features and advantages of the invention will be more apparent from the following more particular description thereof, presented in conjunction with the following drawings wherein:

FIG. 1 shows an architecture diagram of an illustrative embodiment of an anonymous crime reporting and escrow system, which connects reporting users with responders via a centralized, anonymized matching service.

FIG. 2 shows illustrative data flow in a reporting system that encrypts a crime report and hashes perpetrator information before transmitting this data to the matching service.

FIG. 3 shows an illustrative perpetrator matching process that compares hashed tokens of a submitted anonymous complaint to previously submitted hashed perpetrator records in a database.

FIG. 4 shows an illustrative exchange of messages from the centralized matching service to a reporting user and to a responder such as a law firm.

FIG. 5 shows illustrative processing and messaging steps for a reporting user to select a law firm and share a crime report with the firm.

FIG. 6 shows a variation of the flow of FIG. 5, where the law firm first checks for a client conflict before accepting to represent a reporting user.

FIG. 7 shows an example of normalization of perpetrator information into multiple normalized tokens, which are then hashed to form a hashed perpetrator profile.

FIG. 8 shows an illustrative check that may be performed to determine whether a reporting user may be a perpetrator who is for example testing whether he or she has been previously reported.

### DETAILED DESCRIPTION OF THE INVENTION

An anonymous crime reporting and escrow system with hashed perpetrator matching will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

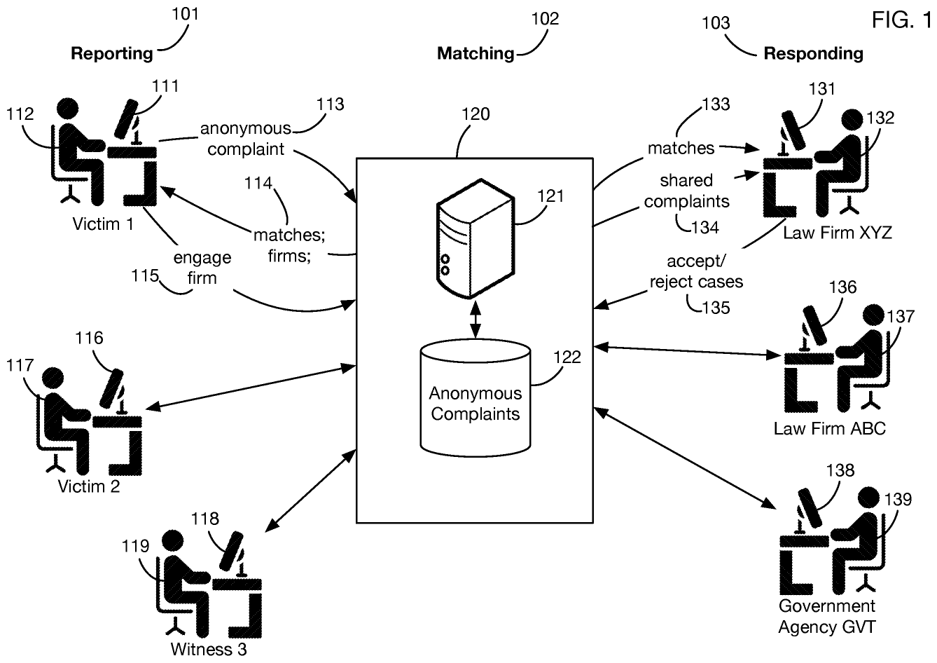

FIG. 1 shows an architecture diagram of an embodiment of the invention. In this embodiment, there are three tiers of systems that are connected to form an anonymous crime reporting and escrow system. The first tier 101 has systems that support reporting users who may generate and submit crime reports anonymously. The crime reports are encrypted so that all information is protected, while still allowing for checking whether there are multiple reports against the same perpetrator, as described below. These features encourage victims to report crimes without fearing that their identities are inadvertently exposed, and without publicly accusing the perpetrator. The second tier 102 contains a centralized matching service that may for example compare anonymous complaints to find common perpetrators, and that may provide services to connect reporting users with potential responders such as law firms that may represent the users. The third tier 103 has systems that support responding users, such as law firms or other services who may represent or otherwise assist the reporting users.

FIG. 1 shows three illustrative reporting users 112, 117, and 119. Users 112 and 117 are victims of crimes, and user 119 is a witness. One or more embodiments may allow any type of user to submit an anonymous complaint, including for example, without limitation, a victim, a witness, an acquaintance of a victim or witness, a counselor, a person with knowledge of the perpetrator, or a law firm who files a report on behalf of their client. Each reporting user may use a computer system with reporting software to generate an anonymous complaint and submit this complaint to the matching tier 102. For example, users 112, 117, and 119 use computer systems 111, 116, and 118, respectively. These systems 111, 116, and 118 may be any type or types of systems or processors, including for example, without limitation, desktop computers, laptop computers, notebook computers, tablet computers, smart phones, server computers, or any combination or network of these devices. Reporting software may execute on the same device that presents a user interface, or an any server or servers connected to these devices.

FIG. 1 shows three illustrative responding users 132, 137, and 139. Users 132 and 137 are law firm representatives (for example, lawyers, legal assistants, or other staff), and user 139 is a representative of a government agency. One or more embodiments may support any type or types of responding users, including for example, without limitation, law firms, employees or partners or other representatives of law firms, or users associated with a legal authority, a victim assistance organization, a government agency, or an employer. Each responding user may use a computer system with response management software to obtain and process notifications, as described below. For example, users 132, 137, and 139 use computer systems 131, 136, and 138, respectively. These systems 131, 136, and 138 may be any type or types of systems or processors, including for example, without limitation, desktop computers, laptop computers, notebook computers, tablet computers, smart phones, server computers, or any combination or network of these devices. Response management software may execute on the same device that presents a user interface, or an any server or servers connected to these devices.

The centralized matching tier 102 may have a matching system 120 with one or more processors 121, typically but not necessarily servers, that execute matching and connecting software. The matching system 120 may also contain a database or databases (or similar data structures) 122 to store the received anonymous complaints submitted by reporting users. The matching tier may perform several functions, as described below, such as checking for repeat offenders, and connecting reporting users with responders in a way that preserves anonymity until the reporting user chooses to share a key that may be used to decrypt the unencrypted data.

Anonymous reports may be escrowed securely in database 122, and may be decrypted only with the permission of the reporting user. If the reporting user chooses to allow decryption of an anonymous report, some or all of this report may for example be used as evidence in a criminal or civil proceeding or in an internal investigation by an organization. This evidence may include for example any data, files, or media the reporting user attached to the crime report, such as for example, without limitation, photos, videos, audio recordings, screenshots, files, message logs, or any other relevant data, files, or media.

The system's decentralized information escrow protocol, described below, enables strict user security and privacy protections by design. The anonymous complaints escrowed in database 122 are owned and controlled by each individual reporting user at all times and are not even accessible (in unencrypted form) to the matching system 120. By design, anonymous complaints do not directly or publicly defame perpetrators. The original unencrypted complaint cannot even be subpoenaed from the matching system 120 to reveal the identifying information of the reporting party. As described below, private keys used to encrypt anonymous complaints are never transmitted to or stored by the matching system 120, so that even if the matching system is hacked the data is fundamentally not able to be decrypted. These privacy and security features allow the system to effectively create accountability and transparency, and to restore trust within institutions that leverage this technology.

FIG. 1 shows several illustrative messages and notifications that may pass between the reporting users or the responding users and the matching system 120. These messages and notifications are described in greater detail below. A reporting user may for example submit an anonymous complaint 113 to the matching system 120, and may then receive notifications 114 in response. These notifications may for example inform the user 112 that there are other reports in the database that mention the same perpetrator. This type of notification may encourage the user to pursue action that he or she might not otherwise pursue if it was not known that other victims were affected. Notifications 114 may also inform the user of law firms or other types of responders that may be available to represent the user. At some point the reporting user may decide to engage one of these firms, and may send a message 115 to the matching system 120 to indicate this decision.

A responding user, such as a law firm 132, may also receive notifications 133 of matches that indicate that a perpetrator may be a repeat offender; this information may for example be of interest to a firm that is already representing an action against a perpetrator, so that the firm knows there may be other victims. When a reporting user sends a message 115 to engage (or consider engaging) a firm, that firm may receive a message 134 with the reporting user's complaint. Some or all of the complaint information may then be decrypted by the responder, at the discretion of the reporting user. The responder may then respond with a message 135 that indicates whether the firm wants to represent this user or not.

These messages shown in FIG. 1 are illustrative; one or more embodiments may support additional types of communications, notifications, and information sharing among any of the parties in the overall system, including between or among any or all of the reporting tier 101, the matching tier 102, and the responding tier 103.

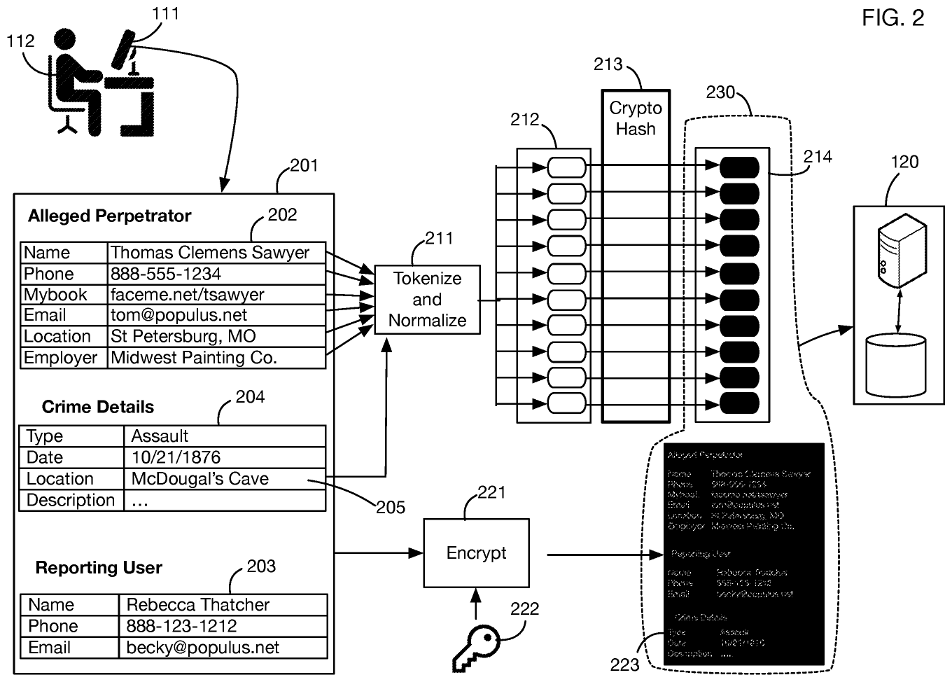

FIG. 2 illustrates processing and transformation steps that may be performed when a reporting user 112 uses a system 111 with reporting software to prepare and submit an anonymous complaint. The reporting software transforms the user's submitted information in such a way that the information is protected and secured, but is also able to be used for matching against other perpetrators without revealing any of the original information. Matching of perpetrators may for example use cryptographic hashes, homomorphic encryption, or any other type of secure encoding of the submitted information. The user prepares a crime report 201, which may for example include information such as identifying characteristics 202 of the alleged perpetrator, identifying characteristics 203 of the reporting user, and details 204 of the crime. The perpetrator characteristics 202 may include for example, without limitation, a perpetrator's name, phone number, social media identity, email address, location, and employer. Some perpetrators may have multiple values for any or all of these fields, such as multiple email addresses or phone numbers for example. Some crime reports may identify multiple perpetrators; the matching process described below may then be used for each of these multiple perpetrators. The reporting user information 203 may include for example, without limitation, any type of contact information such as a name, phone number, or email address. Crime details 204 may include for example, without limitation, any or all of a type of crime, a date or time of the crime, a location where the crime occurred, a description of the crime, and any evidence that the reporting user wants to share such as photos, videos, audio recordings, screenshots, files, message logs, or any other relevant data or media. Users may update report information or upload more evidence after the initial filing of the report; this additional information and evidence will also be encrypted and stored securely. The crime report 201 may be processed in two different ways by system 111. First, the entire report may be encrypted in encryption step 221, using for example a private key 222 associated with and known only to user 112. One or more embodiments may use any type or types of encryption algorithm and any type or types of keys; illustrative encryption methods that may be used are for example AES (with symmetric keys), RSA (with public and private keys), homomorphic encryption, and quantum proofing encryption. This step yields encrypted crime report 223, which can be transmitted and stored but cannot be decrypted or read without the permission of the reporting user 112. In addition, perpetrator identifying characteristics 202 may be transformed via a cryptographic hash function or functions 213 into a set 214 of hashes that represent a hashed perpetrator profile. The perpetrator profile 202 may be augmented with additional information from the crime report, such as for example the location 205 of the crime, and the combined information may be hashed to form the hashes 214. One or more embodiments may use any type or types of hashing functions 213; an illustrative algorithm that may be used is for example any of the variants of SHA (secure hashing algorithm). These hashes 214 may be used to match the perpetrator against previously submitted complaints, as described below. Function 213 may have for example the typical features of a cryptographic hash in that it is not computationally feasible to decode the original perpetrator characteristics 202 given only the hashes. The combination of the encrypted crime report 223 and the hashed perpetrator profile 214 form an anonymous complaint 230 that may be submitted to the matching system 120. The matching process that uses the hashes 214 is described below. In one or more embodiments, perpetrator characteristics 202 or other aspects of the crime report 201 may be encrypted using homomorphic encryption, so that for example the matching system 120 can calculate derived data from the encrypted report without knowing or revealing the original information. For example, homomorphic encryption may be used to compare hashed crime location 205 to other reported locations, and a match of crime locations between reports may be based on a homomorphic calculation of the distance between these locations. Any method of hashing or encrypting location data that permits distance calculations or detection of proximity between locations may be used in one or more embodiments.

The submitted information 230 in the anonymous complaint is completely secure because the key 222 is not transmitted with the complaint, and is not shared with, requested by, or stored by the matching system 120. It is therefore not possible for the matching system 120 to decrypt the anonymous complaint to reveal information in the original crime report 201 without the permission and assistance of the reporting user.

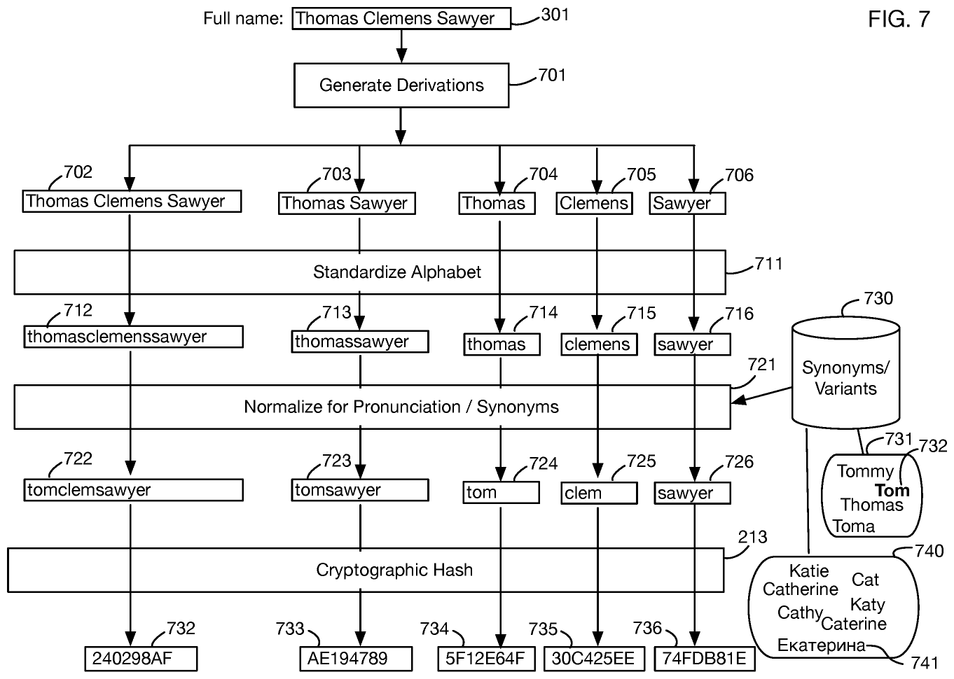

FIG. 2 illustrates an additional processing step that may be performed in one or more embodiments of the invention: the identifying characteristics of the perpetrator 202 may be tokenized and normalized in step 211 before cryptographic hashing 213. This step may for example generate derived information from one or more of the perpetrator identifying fields; for instance, the perpetrator's name may be tokenized into a first name, middle name, and last name. Moreover the tokens may be normalized so that similar tokens have the same normal form, to facilitate matching of hashes. This normalization process may for example allow matches against perpetrators with similar but not identical information, such as name variations. The tokenized, normalized data 212 is hashed in step 213 to form the hashed perpetrator profile 214. This tokenization and normalization process is described below with respect to FIG. 7.

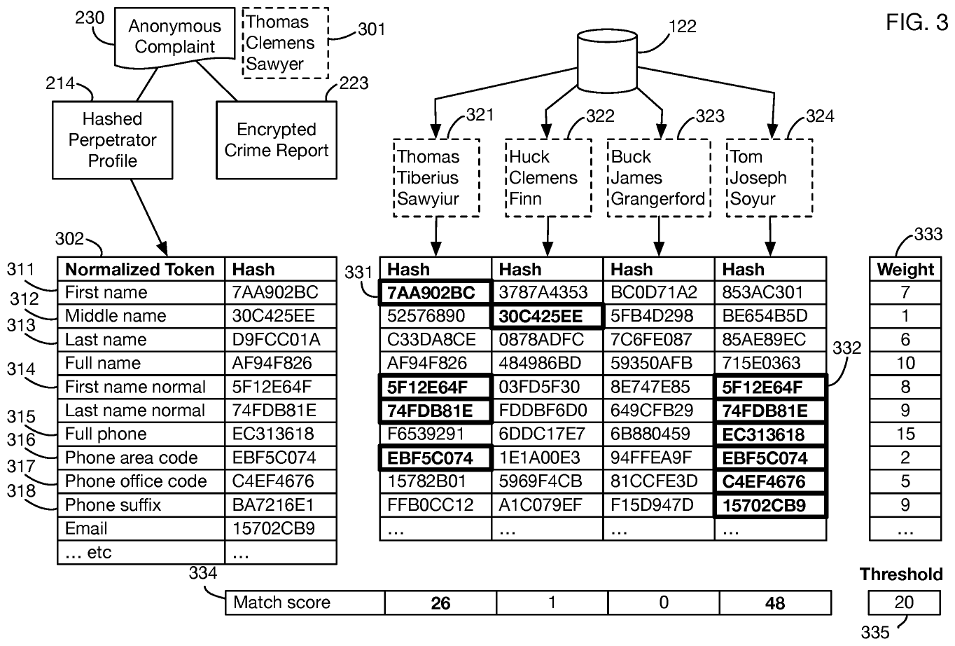

FIG. 3 shows an illustrative method that may be used by matching system 120 to match a submitted hashed perpetrator profile 214 of an anonymous complaint 230 against previously submitted complaints stored in database 122. For illustration, the names of the perpetrators are shown in FIG. 3; however, these unencrypted names are not available to the matching system, and it works only with the hashed values. For example, anonymous complaint 230 is against a perpetrator with name 301, but only the hashes 302 are known to the matching system (along with the encrypted crime report 223 which cannot be decrypted by the matching system). Table 302 show illustrative normalized tokens derived from perpetrator identifying characteristics 202, and illustrative hashes of the normalized token values. For illustration, hashes are shown as 8 hexadecimal digits; one or more embodiments may use hashes of any length and may use any desired hashing algorithm. Normalized tokens first name 311, middle name 312, and last name 313 may be derived as substrings of the perpetrator's full name. The first name normal form token 314 may be derived by mapping the perpetrator's first name into a normalized form, as described for example with respect to FIG. 7. The phone number token 315 may also be split into portions such as the area code 316, the office code 317, and the suffix 318. These normalized tokens are illustrative; one or more embodiments may use any desired perpetrator characteristics and may map these characteristics into any desired normalized tokens using any forms of derivation and normalization.

The hashes in table 302 may then be compared to corresponding hashes from other anonymous complaints that are stored in database 122. FIG. 3 shows four illustrative hashed perpetrator profiles in database 122 for perpetrators with names 321, 322, 323, and 324. (Again, these names are shown for illustration but are not available in cleartext to the matching system.) Hashes that match are shown with a bold outline. For example, the first name hash 331 of perpetrator 321 matches the hash for the first name 311 of the submitted hashed perpetrator profile 214. For perpetrator 324 in the database, the first name does not match but the first name normal form hash 332 does match the hash of the submitted profile normal form 314, since the names “Tom” and “Thomas” may for example have the same normal form.

An illustrative method of determining the strength of an overall match against each entry in the database is to assign a weight to each normalized token, and to sum the corresponding weights for the hashes that match. This is shown in FIG. 3 with illustrative weights 333 and the resulting match scores 334 for each of the perpetrators 321, 322, 323, and 324. Match scores may be compared for example to a threshold value, and if the score exceeds the threshold then the perpetrator is considered a match. For example, with a threshold value 335, perpetrators 321 and 324 are matches against the hashed perpetrator profile 214. The weighted sum method shown in FIG. 3 is illustrative; one or more embodiments may calculate a match score or otherwise determine matches using any desired method.

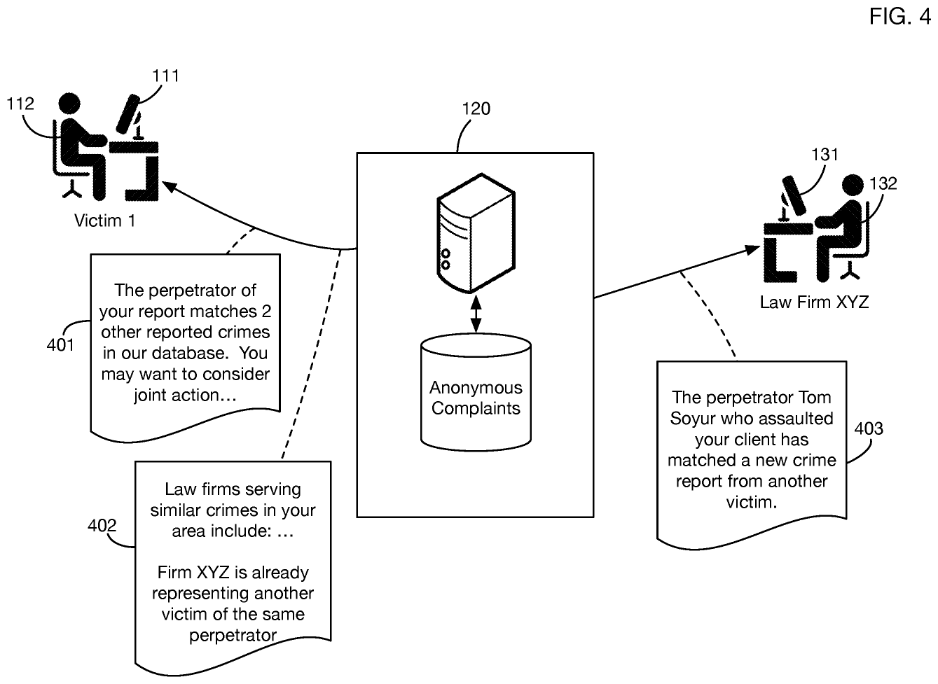

Once the matching system 120 has determined a set of matching perpetrators to a submitted anonymous complaint, one or more notifications may be transmitted to any or all of the reporting user and selected responders. This process is illustrated in FIG. 4, continuing the example of FIG. 3. Notification 401 may be sent to the reporting user 112 who submitted the anonymous complaint. This notification informs the user that there are other complaints against the same (or likely the same) perpetrator that have been previously submitted, and it may indicate the number of other complaints. This notification may for example encourage the reporting user to pursue action or joint action against the perpetrator, since the user may then know that the case is stronger and that the user is not pursuing action all alone. An additional notification 402 may also be sent to the reporting user 112 informing the user of possible law firms (or other responders) that may be of assistance. This list of firms may for example include any firms that are willing to represent this type of case, or cases in the user's geographic area. It may also list one or more specific firms that are already representing other victims of the same perpetrator, or other victims of perpetrators affiliated with the same entity as the perpetrator; this information may encourage the user to contact those firms specifically for a joint action against the perpetrator or the common entity. Such firms 132 may also receive a notification 403 that there is a new match against the perpetrator in a case the firm is pursuing. Importantly, all of these notifications 401, 402, and 403 may be made without revealing any information about the reporting user or even about the details of the user's crime report, since matching is based strictly on cryptographically hashed information that cannot be decoded.

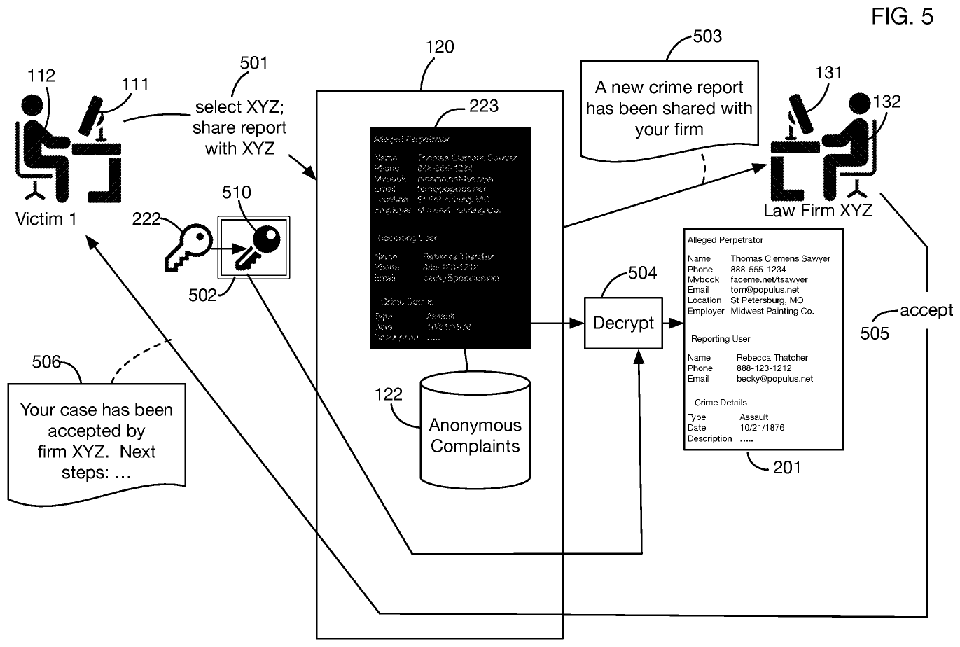

FIG. 5 continues the example of FIG. 4, and shows illustrative processing steps when reporting user 112 responds to notification 402 by deciding to contact law firm 132. The user may transmit a message 501 that he or she has selected this firm and wishes to share information about the crime report with this firm. This message may be sent to the matching system 120, which then sends notification 503 to the responder system 131. If the user chooses to share the entire crime report, then a derived copy 510 of the user's private key 222 may be wrapped in a secure envelope 502 that can only be opened by the responder, and transmitted to the responder system 131. This derived key copy 510 may not be identical to the user's private key 222, but it may be used to decrypt the encrypted crime report. The secure envelope 502 may for example be generated by encrypting the derived key 510 with a public key associated with the responder. The responder can use the responder's private key that is paired with the public key to decrypt the envelope and obtain the derived key 510 that may be used to decrypt the encrypted crime report 223. The encrypted crime report 223 may be sent from the matching system database 122 to the responder, and it may then be decrypted in step 504 using this wrapped key 502. The key 222, and the derived copy 510, are never made available to the matching system 120, and they are never stored in database 122. Therefore only the responder 132 selected by the reporting user 112 can decrypt the crime report and view the information 201. The responder 132 may then decide to accept the case, and transmit an acceptance message 505; the reporting user 112 may then receive a notification 506 that the case has been accepted. In one or more embodiments, the matching system may coordinate additional communications between the reporting user and the responding firm, and may manage the status of the case as it proceeds.

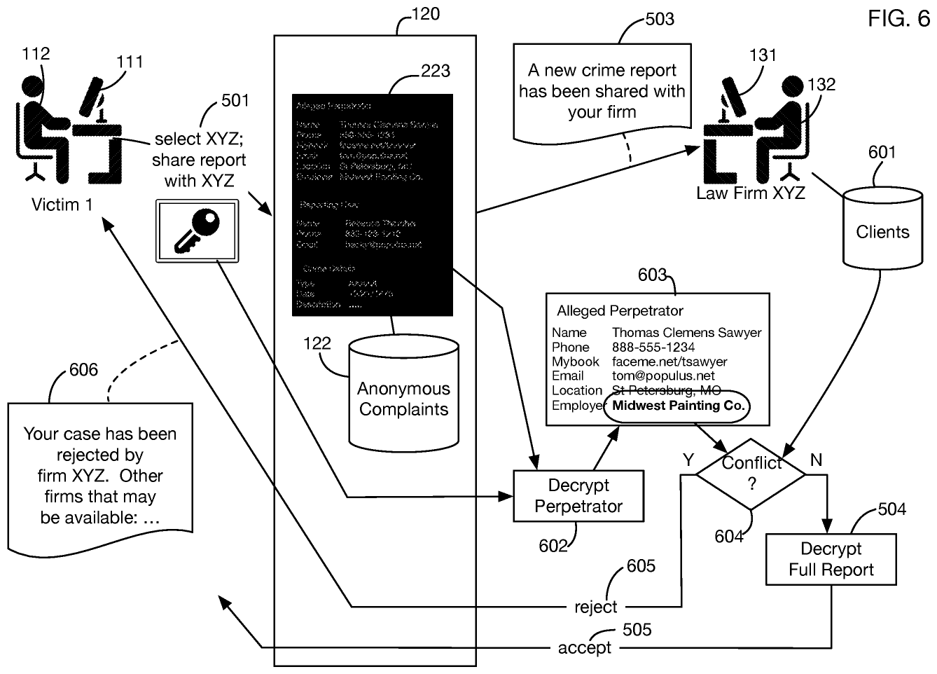

FIG. 6 shows a variation of the scenario of FIG. 5, which allows the responding firm to check for a client conflict before accepting a case. As in FIG. 5, reporting user 112 sends a message 501 that he or she wants to share the crime report with responder 132. In this case, the responding system 131 uses the wrapped key 501 only to perform decryption 602 of enough perpetrator information 603 that the responder can compare the perpetrator to the responder's client database 601. This process allows the responder to perform a check 604 for a conflict, where the responder is already representing the perpetrator or an organization (such as an employer) associated with the perpetrator. If there is a conflict, the responder may send a rejection message 605, which results in a notification 606 to the responding user that this firm cannot or will not take the case; this notification may suggest alternative responders. If there is not conflict, the responder may proceed in step 504 to decrypt the entire crime report, and transmit an acceptance message 505 as in FIG. 5.

FIG. 7 shows illustrative steps to tokenize and normalize perpetrator identifying characteristics. These steps or similar transformations may be used in one or more embodiments prior to calculation of cryptographic hashes, as described above. The example shows processing of illustrative characteristic 301, the perpetrator's full name. Similar steps may be performed on any other perpetrator characteristics. A first step 701 may derive possibly multiple tokens from this single text field 301; for example, derived tokens may include the original full name 702, the name without the middle name 703, the first name 704, the middle name 705, and the last name 706. Derivations 701 may for example split text fields into substrings, and may reorder or recombine these substrings in any manner to create derived tokens. Other types of derivations may include lookups of related values, calculation of any numerical attributes, or combining different fields into derived values. A second illustrative step 711 may for example standardize the alphabet of tokens, for instance by converting all text to lower case and stripping blanks or other non-alphabetic characters. Other transformations may for example substitute letters, simplify alphabets, or eliminate or simplify vowels or syllables. The standardized tokens after step 711 are lower case non-blank tokens 712, 713, 714, 715, and 716. A subsequent step 721 may normalize tokens based for example on a database 730 of synonyms or other normal forms, or based on transformations to a canonical form (using algorithms such as metaphone, for example, or algorithms to simplify or correct spelling or word forms). This step 721 may for example identify words that sound alike but are spelled differently, or identify names that are common variants of one another. Illustrative database of synonyms or variants for names 730 for example has entries 731 that may all be mapped to a normal form 732; thus token 714 is mapped to normal form 724. These final normalized token forms 722, 723, 724, 725, and 726 are then hashed by cryptographic hashing function 213 into hashes 732, 733, 734, 735, and 736, respectively, which are part of the hashed perpetrator profile.

One or more embodiments may also support matching of information that may be submitted in multiple different languages. For example, database 730 may contain multi-language or multi-alphabet versions of names, such as Russian language and Cyrillic alphabet entry 741 in name variants 740. Other information such as addresses, locations, or organizations may be translated from multiple source languages to a common form to enable matching.

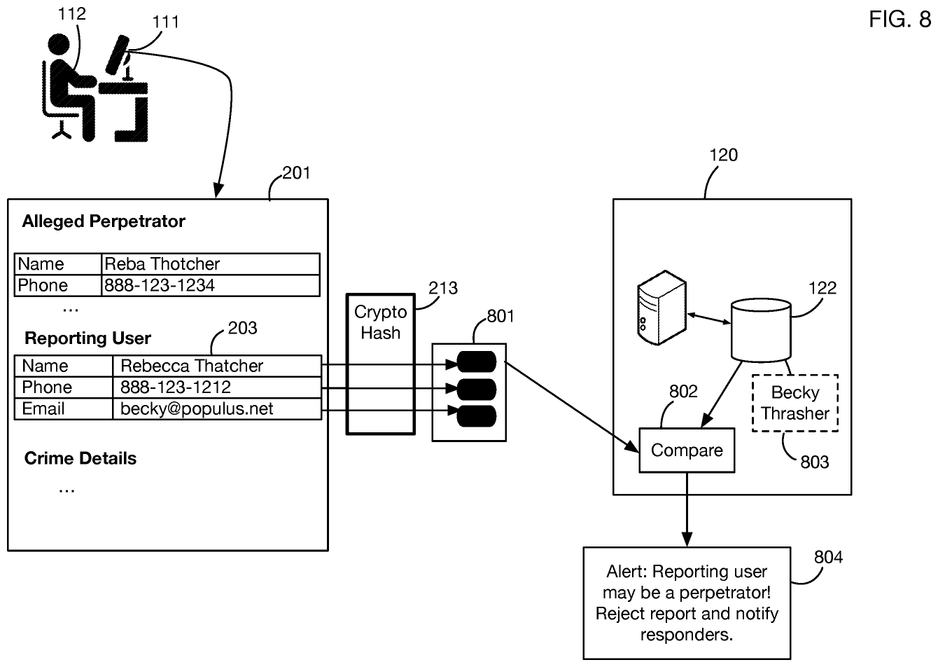

One or more embodiments of the invention may address a situation where a perpetrator attempts to file an anonymous complaint on himself or herself in order to test whether there are entries in the database that match the perpetrator. This situation is illustrated in FIG. 8, where reporting user 203 files a report with a perpetrator name this is a close variant of the user's own name, in order to determine whether anyone has reported the user. The matching system 120 may screen for this scenario by generating a cryptographic hash 801 of all or part of the reporting user's identifying information, and then comparing this information in step 802 to the perpetrators hashes in database 122. If database 122 has a match 803 to data 801, then the system may issue an alert 804 and reject the submitted anonymous complaint; it may also notify authorities, law firms, or other parties.

While the invention herein disclosed has been described by means of specific embodiments and applications thereof, numerous modifications and variations could be made thereto by those skilled in the art without departing from the scope of the invention set forth in the claims.

What is claimed is:

1. An anonymous crime reporting and escrow system with hashed perpetrator matching, comprising:
a reporting system comprising a first processor and a non-transitory computer medium that comprises a first stored program configured to execute on said first processor, wherein when said first processor executes said first stored program, said first stored program is configured to
accept a crime report from a reporting user, said crime report comprising
a plurality of identifying characteristics of a perpetrator;
an identity of said reporting user; and
details of a crime comprising one or more of
a type of said crime;
a location of said crime;
a time of said crime;
transform said plurality of identifying characteristics of said perpetrator to a hashed perpetrator profile comprising a plurality of cryptographic hashes;
transform said crime report into an encrypted crime report;
transmit an anonymous complaint to a second processor, said anonymous complaint comprising
said hashed perpetrator profile; and
said encrypted crime report;
wherein said anonymous complaint does not comprise a key to decrypt said encrypted crime report;
a perpetrator matching system comprising
said second processor and another non-transitory computer medium that comprises a second stored program configured to execute on said second processor; and,
a complaint database comprising
a multiplicity of anonymous complaints; and
hashed perpetrator profiles corresponding to said multiplicity of anonymous complaints;
wherein said complaint database does not store said key to decrypt any encrypted crime report associated with said multiplicity of anonymous complaints;
said second stored program coupled to said complaint database, wherein when said second processor executes said second stored program, said second stored program is configured to
receive said anonymous complaint;
search said hashed perpetrator profiles in said complaint database for a match to said hashed perpetrator profile of said anonymous complaint by comparing said anonymous complaint to said hashed perpetrator profiles previously submitted of said complaint database to find said match;
when said match is found, transmit a notification to one or more of a law firm, a victim assistance organization, a legal authority, a government agency, an employer, and said reporting user,
wherein said notification is configured to inform one more of said law firm, said victim assistance organization, said legal authority, said government agency, said employer, and said reporting user that there are other complaints against the perpetrator that have been previously submitted.

2. The anonymous crime reporting and escrow system of claim 1, wherein said reporting user comprises one or more of
a victim of said crime; and,
a witness of said crime.

3. The anonymous crime reporting and escrow system of claim 1, wherein
said second stored program is further configured to transmit said notification to said reporting user; and,
said notification comprises one or more of
a count of anonymous complaints in said complaint database that match said hashed perpetrator profile of said anonymous complaint; and,
one or more law firms that represent one or more reporting users associated with one or more of said anonymous complaints in said complaint database that match said hashed perpetrator profile of said anonymous complaint.

4. The anonymous crime reporting and escrow system of claim 1, further comprising
a responding system comprising a third stored program configured to execute on a third processor, wherein said third stored program is configured to
receive said notification from said perpetrator matching system; and,
present said notification to a responder that uses said third program.

5. The anonymous crime reporting and escrow system of claim 4, wherein said responder comprises a law firm or a person associated with said law firm.

6. The anonymous crime reporting and escrow system of claim 4, wherein
said first stored program is further configured to
present to said reporting user a list of potential responders that represent cases similar to said crime report;
accept a selected responder from said list of potential responders from said reporting user;
transmit said selected responder to said perpetrator matching system;
said second stored program is further configured to
transmit said anonymous complaint associated with said reporting user to said responding system associated with said selected responder; and,
said third stored program associated with said selected responder is further configured to
receive said anonymous complaint associated with said reporting user; and,
decrypt said encrypted crime report associated with said anonymous complaint to obtain said crime report.

7. The anonymous crime reporting and escrow system of claim 6, wherein said list of potential responders that represent cases similar to said crime report comprise one or more law firms that represent one or more reporting users associated with one or more of said multiplicity of anonymous complaints in said complaint database that match said hashed perpetrator profile of said anonymous complaint.

8. The anonymous crime reporting and escrow system of claim 6, wherein said third stored program is further configured to
present one or more identifying characteristics of said perpetrator to said responder so that said responder can check for a conflict.

9. The anonymous crime reporting and escrow system of claim 6, wherein said third stored program is further configured to
receive from said responder an acceptance or a rejection to represent said reporting user; and,
transmit said acceptance or said rejection to said reporting user.

10. The anonymous crime reporting and escrow system of claim 1, wherein said plurality of identifying characteristics of said perpetrator comprise one or more of a name, a phone number, a location, a social media identifier, an email address, a workplace.

11. The anonymous crime reporting and escrow system of claim 1, wherein said match comprises a sum of hash match scores that exceeds a threshold, wherein said sum of hash match scores comprises a sum of a hash match score for each cryptographic hash of said hashed perpetrator profile that matches a corresponding cryptographic hash associated with a second perpetrator in said complaint database.

12. The anonymous crime reporting and escrow system of claim 1, wherein said transform said plurality of identifying characteristics of said perpetrator to said hashed perpetrator profile comprises
transform each identifying characteristic of said plurality of identifying characteristics of said perpetrator to one or more normalized tokens; and,
calculate a cryptographic hash of said one or more normalized tokens corresponding to said each identifying characteristic.

13. The anonymous crime reporting and escrow system of claim 12, wherein said transform each identifying characteristic of said plurality of identifying characteristics of said perpetrator to one or more normalized tokens comprises
convert an identifying characteristic of said plurality of identifying characteristics to lower case and remove one or more non-alphabetic characters.

14. The anonymous crime reporting and escrow system of claim 12, wherein said transform each identifying characteristic of said plurality of identifying characteristics of said perpetrator to one or more normalized tokens comprises
transform an identifying characteristic of said plurality of identifying characteristics to one or more substrings of said identifying characteristic.

15. The anonymous crime reporting and escrow system of claim 14, wherein
said identifying characteristic of said plurality of identifying characteristics comprises a full name; and,
said one or more substrings comprise one or more of a title, a first name, a middle name, a last name.

16. The anonymous crime reporting and escrow system of claim 14, wherein
said identifying characteristic of said plurality of identifying characteristics comprises a phone number; and,
said one or more substrings comprise one or more of a country code, an area code, a central office code, a suffix.

17. (canceled)

18. The anonymous crime reporting and escrow system of claim 12, wherein said transform each identifying characteristic of said plurality of identifying characteristics of said perpetrator to one or more normalized tokens comprises
transform an identifying characteristic of said plurality of identifying characteristics to a synonym or variation of said identifying characteristic.

19. The anonymous crime reporting and escrow system of claim 1, wherein said second stored program is further configured to
reject said anonymous complaint when said identity of said reporting user matches any hashed perpetrator profile in said complaint database.
